(19) United States
(12) Patent Application Publication
(10) Pub. No.: US 2011/0277041 A1
(43) Pub. Date: Nov. 10, 2011

(54) CIRCUIT CARD DATA PROTECTION

(75) Inventor: Olivier Dong, Berkshire (GB)

(73) Assignee: NEC CORPORATION, Tokyo (JP)

(21) Appl. No.: 13/144,866

(22) PCT Filed: Dec. 28, 2009
(86) PCT No.: PCT/JP2009/071926

§ 371 Date: Jul. 15, 2011

(30) Foreign Application Priority Data
Jan. 16, 2009 (GB) 0900664.4

(51) Int. Cl. G06F 21/24; G06K 19/073; G06F 21/02

(52) U.S. Cl. 726/30

(57) ABSTRACT

The present invention provides for a method data of achieving protection in a circuit card such as a UICC arranged for storage of a plurality of data elements and providing protection on the basis of a domain protection-element serving to define operations that can be permitted on a data element, and on the basis of a password protection-element serving to control access to a data element and wherein at least one of the plurality of data elements is associated with both a domain protection-element and a password-protection element, and the invention further provides for a circuit card arranged for the secure storage of such data elements and for a ME arranged to employ such a circuit card.

### TECHNICAL FIELD

The present invention relates to a circuit card and in particular an arrangement, and method, for the protection of data stored therein.

### BACKGROUND ART

With their ongoing increase in functionality, hand held devices such as cell phone handsets and other forms of Mobile Equipment (ME) have proved popular devices/interfaces for the storage and holding of large amounts of (personal) data.

Such data can comprise private pictures, videos and SMS messages for example and users generally have the option of storing such data either within the ME, the relevant part of a Universal Integrated Circuit Card (UICC) such as a Subscriber Identity Module (SIM) card, or indeed in network-side storage areas provided by the network operators, or on other media devices such as memory cards.

In view of the amount and potentially private/sensitive nature of the data to be stored, from an end-users perspective, the storage area should offer sufficient storage capacity, an appropriate level of security and also be readily accessible.

While the ME itself can be thought of as providing an appropriate degree of security, such levels of security tend to be specific to a particular ME manufacturer and storage capacity is not considered sufficient for all types of user data, in particular multimedia data. Accessibility to the data likewise generally also requires a manufacturer-specific cable and related connectivity software.

While devices such as memory cards can offer large storage capacity and ready accessibility, there is no ready means for protecting or offering suitable protection for user data.

With regard to network-side storage areas, a high degree of security can be achieved along with sufficient storage capacity although accessibility will of course be dependent on network access availability which might be far from guaranteed.

Circuit cards such as a UICC comprise potentially attractive storage locations insofar as from recent developments, such as arising from 3GPP/ETSI Rel-7, UICC supporting high density memory are available and, from the same specification, the provision of an new interface based on the USB 2.0/USB Inter-Chip is proposed between the UICC and ME which will greatly ease and speed-up data exchange with the UICC such that data retrieval, for example to an PC, can be readily achieved by way of a simple adaptor.

### CITATION LIST

### Patent Literature

PTL 1: International Patent Publication No. WO 2008/139615
PTL 2: US Patent Publication No. 2008/254834
PTL 3: US Patent Publication No. 2008/256629
PTL 4: US Patent Publication No. 2008/155830

### SUMMARY OF INVENTION

### Technical Problem

However, while the UICC is considered to be relatively secure particularly through the use of Personal Identification No. (PIN) codes, limitations remain insofar as, once the PIN has been verified, which generally occurs merely when a user wishes to activate the USIM/GSM application, the stored user data is then likewise freely accessible without requiring any further security checks.

That is, once the ME carrying, for example, the USIM has been appropriately “activated” for use by way of entry of a correct PIN, all other data stored on the USIM is readily accessible which, particularly if the current end user is only intended to have temporary access to the ME might not be appropriate.

International Patent Publication No. WO 2008/139615 discloses a memory card, access control system, and access control method which allows for the dynamic changing of the scope of the service, and the provision of different services depending on the user through the performance of access management according to information associated with the content to be downloaded and in which the circuit card includes a data management section and relies upon the dynamic changing scope of service rather than a provision of a security mechanism to protect the data on the card.

Further, US Patent Publication No. 2008/254834, No. 2008/256629 and No. 2008/155830 each disclose memory cards offering a secure storage of content to through the provision of the comparison of user identifiers and so which exhibit the limitations of the prior art and as discussed further above.

The present invention seeks to provide for a circuit card, and in turn an ME including such a card, and a method of data protection within such a card, and having advantages over known such cards and methods.

In particular, the present invention seeks to provide for a UICC, and method for providing security and data therein, and having advantages over known such cards and methods.

### Solution to Problem

According to one aspect of the present invention there is provided a method of data protection in a circuit card arranged for storage of a plurality of data elements comprising; providing protection on the basis of one of a domain protection-element serving to define operations that can be permitted on a data element and a password protection-element serving to control access to a data element, wherein at least one of the said plurality of data elements is associated with both the domain protection-element and the password-protection element.

The invention is advantageous insofar as, through the provision of one or more domain protection-elements, the degree of security of the data stored on the circuit card can be readily enhanced and, indeed, provided in a flexible and readily adaptable manner.

Such circuit cards can therefore advantageously offer an end user appropriate level of security, capacity and accessibility for, in particular, user-specific and sensitive data.

A particular enhanced level of security is offered through the combination of the above mentioned “password” and “domain” features insofar as they can provide, in combination, protection for a data element, such as a partition, directory or file. The “password” feature provides protection in a manner independent of the nature of operations that might be allowed once the password has been verified and access to the data element allowed, whereas the “domain” features define possible operations that can be allowed on the data elements such as the aforementioned partition, directory or file.

In one particular example, the circuit card comprises a UICC.

Yet further, an additional level of security can be provided through use of a PIN access code to one or more applications of the circuit card.

Preferably, each of the said plurality of data elements is associated with a domain protection-element.

Advantageously, the permitted operations defined by the domain protection element can comprise one or more of read and/or write access operations.

Yet further in accordance with the method of the present invention, an entity that is capable of accessing data in the circuit card is arranged to be associated with a unique identifier.

The method also can include storing the identity of an entity creating the data element.

Further, and with regard to an ME arranged for use with a circuit card embodying the invention, the method can include the steps of, within the ME, identifying and entity requiring access to the said data.

Advantageously, the method is such that the data protection steps are applied over USB interface classes between the ME and the circuit card.

Advantageously, the data element can be stored on the circuit card in accordance with a standard file format file system.

Yet further, creation and management of the data elements can be achieved by way of the creation and management of the data elements within the circuit card and can be provided by way of the ME.

Also, the ME-circuit card interface functions can be defined as including one or more of a create function, read function, update function, rename function, move function, delete function and cleaning function.

According to another aspect of the present invention there is provided a circuit card arranged for storing a plurality of protectable data elements comprising; at least one of the said plurality of protectable data elements that are arranged to be associated with both a domain protection-element serving to define operations that can be permitted on the data element and a password protection-element that serves to control access to the data element.

Preferably, the circuit card comprises a UICC.

The said at least one data element can be arranged such that a password is required to initiate the operation permitted by the domain protection-element.

Preferably, each of the plurality of data elements can be associated with a domain protection-element.

Also, the aforesaid operations defined by the domain protection-element comprise at least one of read and/or write access operations.

Advantageously, the circuit card can be arranged to allow access to the said data elements by way of a USB interface.

Further, the circuit card can be arranged to have the said data elements stored within a standard file on that file system.

The invention also provides for an ME arranged for receiving a circuit card as defined above.

Advantageously, the ME can be arranged to communicate with the circuit card by way of a USB interface class.

Advantageously, the ME can be arranged to create and/or manage the said stored data elements.

Preferably, the ME-circuit card interface functionality is defined by one or more of a create function, read function, update function, rename function, move function, delete function and cleaning function.

The invention is described further hereinafter, by way of example only, with reference to the accompanying drawings in which:

### ADVANTAGEOUS EFFECTS OF INVENTION

According to the present invention, through the provision of one or more domain protection-elements, the degree of security of the data stored on the circuit card can be readily enhanced and, indeed, provided in a flexible and readily adaptable manner.

### BRIEF DESCRIPTION OF DRAWINGS

FIG. 1 is a schematic plan view of a UICC according to an embodiment of the present invention;

FIG. 2 is a schematic plan view of a mobile radio communications device, or ME, in the form of a cell phone handset and arranged for operation with the UICC of FIG. 1;

FIG. 3 is a signalling timing diagram is relation to the creation of a directory within the UICC within a UICC according to the present invention;

FIG. 4 is a signalling timing diagram for the creation of the file for such a UICC.

FIG. 5 is showing a signalling timing diagram for the attempted reading of a protected file using an incorrect password.

FIG. 6 is showing a signalling timing diagram for the attempted reading of a protected file using a correct password.

### DESCRIPTION OF EMBODIMENTS

As will be appreciated from the above, and from the following further detailed description of a particular embodiment, the present invention advantageously seeks to address limitations found in current circuit cards such as those relating to the provision of a data protection mechanism based simply on PIN codes. As noted, they are primarily related to an application, for example GSM/USIM, and its related data such as IMSI or PLMN lists etc and wherein data not directly linked with any such application, for example such as user private files photographs, videos, personal messages fall under that same security regime.

The present invention defines a data protection mechanism which, if required, can be used in addition to existing PIN protection, in order to offer an enhanced level of security for all types of data stored on the circuit card.

Also, data storage within circuit cards is currently based on Elementary Files which are not adapted to the storage of large amounts of data. Also, such files are often not specified to store some types of data such as video and music files. A new data storage arrangement is therefore proposed as part of the present invention and finds particularly advantageous uses in association with the improved circuit-card security.

Turning first to FIG. 1, there is provided a schematic illustration of one example of circuit card in relation to which the present invention can advantageously be embodied.

A circuit card comprises a UICC 10 which includes processing functionality 12 provided between a storage area 14 and ME interface 16.

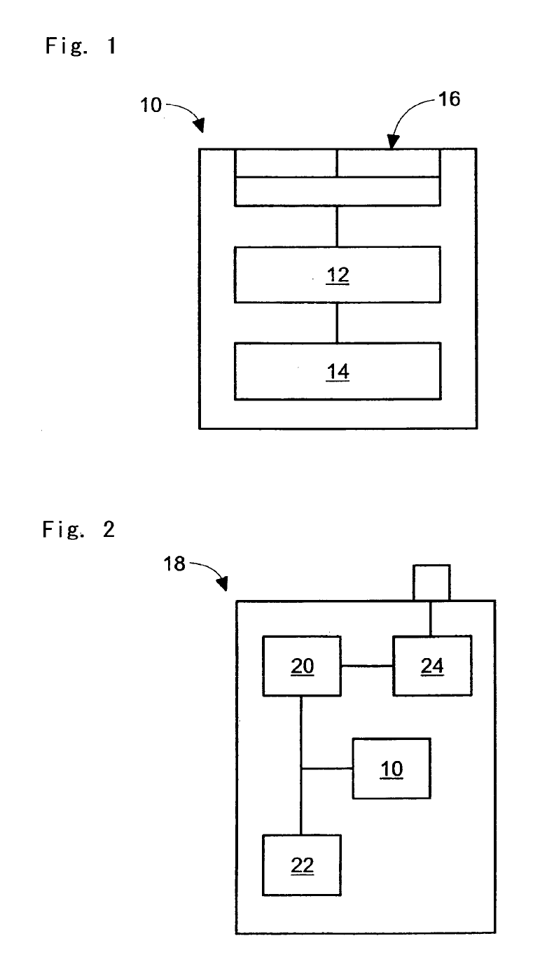

As will be described further below, the interface 16 can be advantageously based on the USP 2.0/USP Inter-Chip which eases, and speeds up, data exchange between, for example, the UICC 10 and a PC to which the cell phone handset 18 of FIG. 2 can be connected by way of a simple electrical adaptor.

With regard to FIG. 2, there is provided a schematic diagram of a mobile radio communications device, which could comprise any form of Mobile Equipment (ME), such as a cell phone handset 18, within which the UICC 10 of FIG. 1 is provided and in association with standard memory 22, processor 20 and transmit/receive functionality 24 as indicated.

Of the various storage options that could be offered by way of cell phone handset 18, the UICC 10 can provide an advantageously secure, readily accessible and suitably large, storage location and as based on the combination of domain security-elements and password security-elements as noted above and as discussed further below.

In relation to the current description and definition of the present invention, it should be appreciated that a “password” protects the access to a file/directory/partition independently from what operations would be allowed once the password will be checked. In comparison, a domain defines serves to the different operations that a particular entity can carry out on a file/directory/partition.

In one particular example therefore, each data element such as a file, directory or even a partition can be associated with a domain and could be possibly protected by a password (in case the associated domain requires a password). A variety of domains with their respective definitions of allowed operations can be provided and generally in a standardized manner in order to allow for interoperability.

As examples, possible domains can be as follows:

“Private” in which only the owner (the entity which created the file/directory/partition) can have access. All rights are granted once the password has been successfully checked

“Restricted Read Write” in which read and write access rights are granted to any entity if it successfully passes the password check

“Restricted Read” in which read access rights are granted to any entity if it successfully passes the password check

“Read Only” which are readable by any entity without password.

“Public” in which read and write access rights granted for any entity without password

Any entity such as particular users and/or other devices/equipment capable of accessing data in the UICC is associated with a unique identifier called “entity_id”. This identifier is preferably allocated by the UICC upon a request from the ME and the “request/result” structures can be as follows:

From ME to UICC: Generate Entity_Id_Req (entity_name)

From UICC to ME: Generate Entity_Id_Res (result, entity_name, entity_id);

The “entity_name” is a publicly available name of entities which are able to access data in the UICC.

This particular illustrated example suggests that at least the following public entities with their respective entity_names are defined:
The user (USER)
The ME (ME)
A remote server (REMOTE SERVER)
A third party application within the ME (ME_THIRD_PARTY)

It should of course be appreciated that list is not exhaustive, and may therefore comprise other entities.

The “entity_id” is a private identifier allocated by the UICC for a given “entity_name”.

The “entity_name, entity_id” pairs shall be saved in the memory of the ME and the ME shall guarantee the confidentiality of these pairs.

Advantageously, the ME is responsible for accurately identifying the requesting entity (entity which wishes to access the data in the UICC), e.g. if a request is coming from a ME application, then the ME shall use the entity_id associated with the ME in the interface functions defined in this document.

A simple way for the ME to identify different requesting entities may be based in the use of their respective thread or process identifier allocated by the ME operating system.

The UICC can rely on the fact that the “entity_id” passed by the ME is accurate since some operations directly depend on this entity_id. Thus, providing such an accurate “entity_id” from the ME to the UICC serves to enhance the security mechanism defined in this proposal.

When a file/directory/partition is created, the UICC can associate the notion of “owner” for the created element. For that purpose, the UICC simply takes the “entity_id” passed in the creation request function and saves it as the owner entity_id of the created element.

This notion of ownership can prove important since many operations are only allowed for the owner of a file/directory/partition (e.g. elements defined in the “private” domain as defined above are only accessible to the owner).

A variety of security interface functions can be employed. First a setting password function wherein an entity can use this function only for its own files/directories/partitions. If the UICC, when receiving the request, realizes that the received entity_id doesn't match the owner entity_id, the request is rejected and the “request/result” structures can be as follows:

From ME to UICC: Set_Password_Req (entity_id, pathname, password)

From UICC to ME: Set_Password_Res (result, entity_id, pathname)

The entity_id is provided so that advantageously only the owner of the partition/directory/file is allowed to execute the request. The pathname comprises the path including the name of the partition/directory/file, and the password comprises the password set to the partition/directory/file. The end result will be either success or failure.

A change password function can be used by an entity but only for its own files/directories/partitions.

If the UICC, when receiving the request, realizes that the received entity_id doesn't match the owner entity_id, the request is rejected, and with the following “request/result” structure.

From ME to UICC: Change_Password_Req (entity_id, pathname, old_password, new_password)

From UICC to ME: Change_Password_Res (result, entity_id, pathname)

Similar parameters to those noted above are employed along with an old_password which comprises current password of the partition/directory/file, and a new_password which comprises the new password to be set to the partition/directory/file.

Request/result structures for a verify password function can be as follows.

From ME to UICC: Verify_Password_Req (entity_id, pathname, password)

From UICC to ME: Verify_Password_Res (result, entity_id, pathname)

In one arrangement, the number of “attempts” can be limited to three for the password verification for each entity against one given protected element (file or directory or partition). After three failed attempts, the element is no longer accessible to the entity which made those attempts until the access conditions is changed for the element (e.g. the owner of this element changes or removes the password).

It can be arranged that an entity can use a “set domain” function only for its own files/directories/partitions.

If the UICC, when receiving the request, realizes that the received entity_id doesn't match the owner entity_id, the request is rejected and the “request/result” structure is as follows.

From ME to UICC: Set_Domain_Req (entity_id, pathname, domain)

From UICC to ME: Set_Domain_Res (result, entity_id, pathname)

A get domain function can also be provided with the following “request/result” structures.

From ME to UICC: Get_Domain_Req (entity_id, pathname)

From UICC to ME: Get_Domain_Res (result, entity_id, pathname, domain)

Further an access condition notification function can be provided with a corresponding structure as follows.

From UICC to ME: Access_Condition_Notification (entity_id, pathname, condition)

Similar parameters to those noted above are employed with the addition of a condition parameter which comprises the condition that needs to be verified for the element indicated by pathname (e.g. requires a password).

One entity identifier creation function can be provided with the “request/result” structure below.

From ME to UICC: Generate_Entity_Id_Req (entity_name)

From UICC to ME: Generate_Entity_Id_Res (result, entity_name, entity_id);

For the related parameters, the entity_name again comprises the public name of an entity, and entity_id comprises a unique identifier allocated by the UICC for each entity-name.

As further illustrations of an example of this aspect of the present invention, below are examples of implementation of the invention and in relation to the possible domains noted above.

First, a User takes a picture and saves the image file in “/partition1/directory1/image1.jpg”. The partition) domain is defined as “Restricted Read Write”. “directory1” and “image1.jpg” are not protected by password.

The User or any other entity is willing to access the “image1.jpg” file and the only condition is that they need to know the password for “partition)”.

As a second example, the User takes a picture and saves the image file in “/partition1/directory1/image1.jpg”. The “partition1” and “directory1” domains are defined as “public” (therefore no password). “image1.jpg” is protected by password (domain “Restricted Read”).

The User or any other entity is willing to read the “image1.jpg” file and the only condition is that they need to know the password for “image1.jpg”.

In a third example, the User takes a picture and saves the image file in “/partition1/directory1/image1.jpg”. The “partition1” domain is defined as “private”. “directory1” and “image1.jpg” are not protected by password.

The User or any other entity is willing to access the “image1.jpg” file. However, only the User will be able to access the file following successful password verification. Any other entity, even if it has the correct password, cannot access the file (as its entity_id doesn't match the owner entity_id).

For a fourth example, the User takes a picture and saves the image file in “/partition1/directory1/image1.jpg”. The “partition1”, “directory1” and “image1.jpg” domains are defined as “Read Only”.

For a first operation for this example, the User or any other entity is willing to read the “image1.jpg” file and the file data is directly accessible as no password is required to read the file.

However for a second operation, the User or any other entity is willing to update the “image1.jpg” file but only the owner (User) will be able to access the file following successful password verification.

As will be appreciated, the invention can readily take into account the fact that future UICC-ME large data operations will be mainly achieved over a USB interface. The illustrated example is therefore aimed at implementation over the ME-UICC interface based on USB and supporting the EEM (Ethernet Emulation Mode) interface class. However, the principle of this solution could be also applied over other USB interface classes like Smart Card CCID (Integrated Circuit(s) Cards Interface Device).

In this regard, it should be appreciated that a USB packet has a format in which the EEM Packet comprises the payload of the USB packet. The EEM packet itself has a format defined as either an EEM Data or EEM Command format.

The EEM Command packets are used for the local USB link management, and therefore cannot go beyond the USB device driver layer. Therefore, all the interface functions defined of this illustrated example will be encapsulated in the payload part of EEM Data type packets.

As noted above, the invention also includes features serving to allow for improved data storage, in order to enhance the support of large size/multimedia data, for which the current file system based on Elementary Files has some limitations. This aspect of the invention proposes to replace most of the existing Elementary Files file system by a standard file format file system.

For that purpose, particular ME-UICC interface functions are defined in order to permit the ME to create and manage partitions/directories/files in the UICC.

Examples of such ME-UICC function are outlined below.

A Creation function employed to (create a partition or directory or file) can be associated with a “request/result” structure as follows.

From ME to UICC: Create_Element_Req (entity_id, element_type, pathname, element_parameters)

From UICC to ME: Create_Element_Res (result, entity_id, pathname, additional_info)

The parameters employed therein can be defined as follows.
entity_id: indicates the entity which sent the creation request
element_type: a partition or directory or file
pathname: contains the “path+name” of the element to be created, e.g. “/partition/global_directory/directory1/image1.jpg”
element_parameters: parameters specific to a given element type (e.g. the size in case of a partition, the file type in case of a file, etc. . . . )
result: contains the request execution result (success, failure, successful with modification, . . . )
additional_info: when the UICC sends more information than the simple execution result, these additional pieces of data are included in this parameter (e.g. in case the UICC created a partition with a size which is different from the requested one)

A Read function employed to (read a partition or directory or file) can be associated with the following request/result structure.

From ME to UICC: Read_Element_Req (entity_id, pathname)

From UICC to ME: Read_Element_Res (result, entity_id, pathname, data)

and here the parameters can be defined as:
entity_id: indicates the entity which sent the reading request
pathname: contains the “path+name” of the element to be read
result: element reading result (success or failure)
data: contains the data of the read element (e.g. the list of directories and files located under a read partition/directory or the content itself in case of a file)

An Update function can be provided but only defined for files and related to the following request/result structure.

From ME to UICC: Update_File_Req (entity_id, pathname, data_type, data)

From UICC to ME: Update_File_Res (result, entity_id, pathname)

Here the parameters comprise:

entity_id: indicate the entity which sent the update request
pathname: contains the “path+name” of the file to be updated. e.g. “/partition/global_directory/directory1/image1.jpg”
data_type: indicates the type of data in the file, e.g. jpg, mpeg, txt, etc. . . .
data: content of the file
result: file updating result (success or failure)

A Rename function can be related to the following request/result structure.

From ME to UICC: Rename_Element_Req (entity_id, old_pathname, new_name)

From UICC to ME: Rename_Element_Res (result, entity_id, new_pathname)

And the parameters can be defined as:
entity_id: indicate the entity which sent the rename request
old_pathname: contains the old “path+name” of the element to be renamed
new_name: contains just the new name (no path) of the element to be renamed
result: renaming execution result (success or failure)
new_pathname: contains the “path+new name” of the element that has been renamed

Move functions can be embodied by

From ME to UICC: Move_Element_Req (entity_id, old_pathname, new_pathname)

From UICC to ME: Move_Element_Res (result, entity_id, new_pathname)

And with the parameter definitions
entity_id: indicates the entity which sent the moving request
old_pathname: contains the old “path+name” of the element to be moved
new_pathname: contains the new “path+name” of the element that has been moved
result: moving execution result (success or failure)

Delete functions can likewise be provided and in accordance with request/result structures such as

From ME to UICC: Delete_Element_Req (entity_id, pathname)

From UICC to ME: Delete_Element_Res (result, entity_id, pathname)

The parameter definitions can be
entity_id: indicates the entity which sent the deletion request
pathname: contains the “path+name” of the element to be deleted
result: deletion execution result (success or failure)

It should be noted that if the pathname includes some parent directories which are protected, then the access conditions for these directories must be first fulfilled before processing this request.

Cleaning functions can also be provided and serve to delete a partition/directory/file in case the owner has lost/forgotten the associated password (and therefore cannot access any data in the partition/directory/file).

Only the owner of the partition/directory/file can perform this operation.

The UICC has to check that the passed entity_id corresponds to the owner entity_id and the related “request/result” structures are as below.

From ME to UICC: Clean_Element_Req (entity_id, pathname)

From UICC to ME: Clean_Element_Res (result, entity_id, pathname)

There the parameter definitions can:
entity_id: only the owner will be able to achieve this request.
pathname: contains the “path+name” of the element to be cleaned (i.e. deleted)
result: cleaning request result (success, failure)

Further functions can also be provided such as, for example, relating to a resize partition and with the “request/result” structures as follows.

a) Resize Partition

From ME to UICC: Resize_Partition_Req (entity_id, name, new_size)

From UICC to ME: Resize_Partition_Res (result, entity_id, new_allocated_size)

The related parameters can be defined as:
entity_id: indicate the entity which sent the resize request
name: name of the partition
new_size: contains the new required memory size for the partition
result: partition resizing result (success, failure, successful with modification (e.g. in case the allocated size is different from the requested size)
new_allocated_size: represents the real memory size of the partition allocated by the UICC.

It should of course be appreciated that these interface functions can be provided in combination as required.

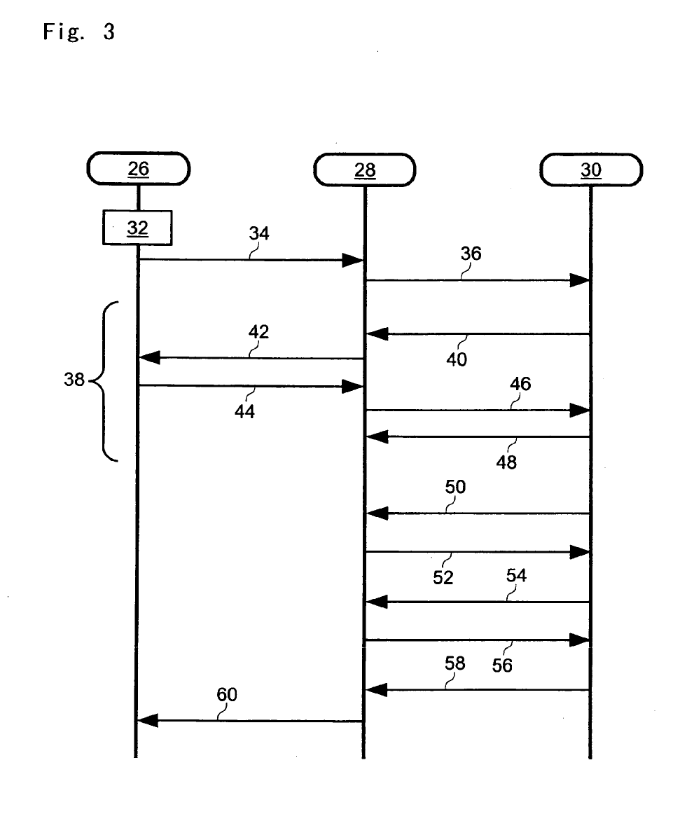

Turning now to FIG. 3, there is provided a signaling timing diagram relating to a sequence of signals arising for the creation of a directory within the memory storage area of the UICC 10 of FIG. 1.

The sequence of signals is those arising between an end user 26, an ME 28 such as a cell phone handset, and an UICC 30 such as the UICC 10 of FIG. 1.

The sequence illustrated in FIG. 3 commences with a request 32 from the user 26 for the creation of the directory in an existing partition/directory and so an appropriate request operation 34 is sent to the ME 28 and which can contain a password name, domain and password.

The user 26 does not set a password for the directory if the domain is required to be “public” and so the “password” parameter will be a null string.

The ME 28 subsequently delivers a Create_Element_Request 36 to the UICC 30 and which includes the entity_id, element_type, pathname and element_parameters.

It should be noted within the present example that for the creation of the directory “element_type” is set to “directory” and “element_parameters” has a null value.

The subsequent passage of signaling comprises a password verification sequence 38 which is related to the parent directories but which will not be required if the parent directories are not protected by passwords. If, however, there are several levels of directories which are protected, passwords for each directory must then be verified.

The password verification sequence 38 commences with an access_condition_notification signal 40 including a parent-directory-path and also confirming the condition that a password is required.

Notification 42 that a password is required is delivered from the ME 28 to the ME user 26 who, in turn, provides a password 44 back to the ME 28 which in turn delivers a verify_password_request signal 46 to the UICC 30. This in turn provides a verify_password_result signal 48 to the ME 28 and a further signaling exchange then occurs between the UICC 30 and the ME 28 and which comprises a create_element result signal 50, a set_domain_request signal 52, a set_domain_result signal 54, a set_password_request signal 56 and a set_password_result signal 58 although it should be appreciated that such setting password functions can not arise if the password value is null.

The sequence concludes with a creative directory result signal 60 delivered from the ME 28 to the user 26.

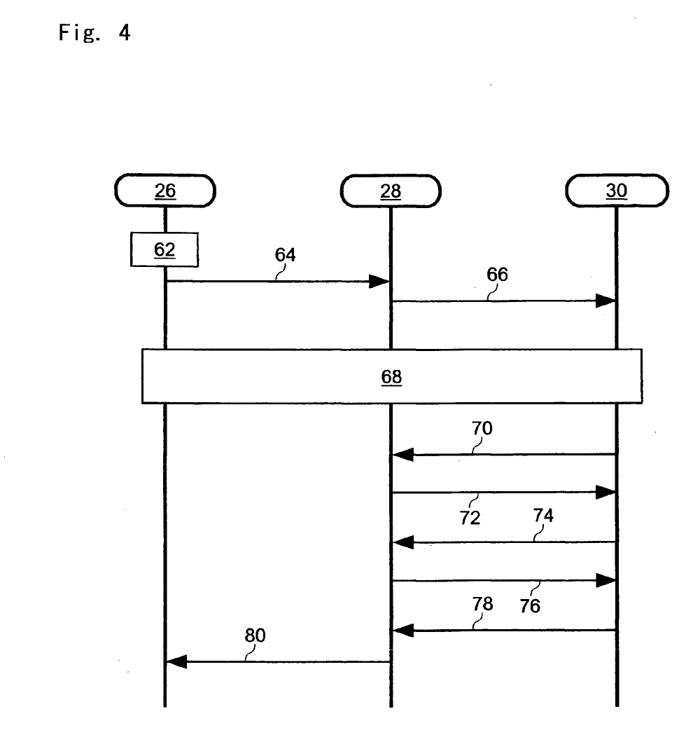

By way of comparison, further details of characteristics of this embodiment of the present invention are shown with reference to FIG. 4 which illustrates a sequence of signals arising in relation to the creation of a file.

The signaling is again illustrated in relation to a user 26, ME 28 and UICC 30.

In this example it is assumed that the end user takes a picture using the camera function of the ME and decides to save the picture in an existing partition/directory. At 62 a decision is made to save the picture in an existing partition/directory and so the user 26 provides a create file request 64 to the mobile equipment 28 and which creates file request 64 including a path name, domain, password and data_type in relation to relevant data.

Subsequently, a create_element_request 66 is delivered from the ME 28 to the UICC 30 and in which, for the creation of the file, the element_type is set to “file”, and the element_parameters contain file_type such as JPG or MP3, and the data, i.e. the content of the file itself.

If at 68 it is found that there are directories which are protected by a password before reaching the location to create the file, the password for each of directory is supposed to be verified and a verification sequence 38 such as that illustrated in FIG. 3 can likewise be employed with the sequence of FIG. 4.

That is, a create_element_result 70 is delivered from the UICC 30 to the ME 28 and, in reply a set_domain_request signal 72 is delivered to the UICC 30 which then initiates a set_domain_results signal 74. Assuming that the password is not set to “null” a set_password_request 76 is delivered from the ME 28 to UICC 30 and, in response, a set_password_result 78 is delivered from the UICC 30 to the ME 28. Upon conclusion of the signaling exchange 70-78 between the ME 28 and UICC 30, creating a file result indication 80 is provided by the ME 28 to the end user 26.

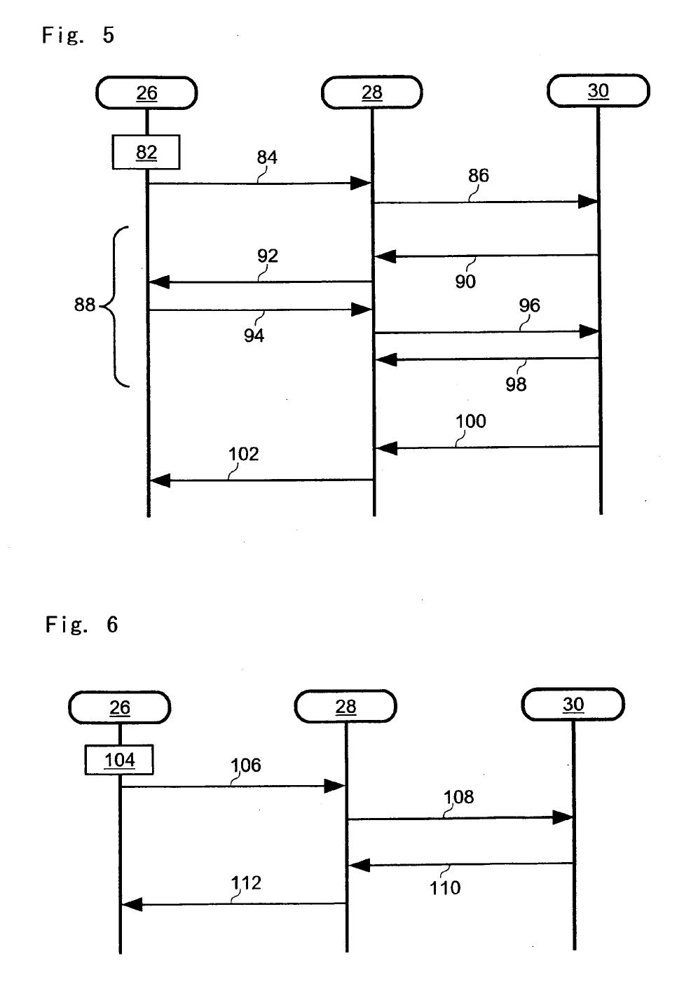

Turning finally to FIGS. 5 and 6, there are here provided signaling diagrams relating to the attempted reading of a protected file in an instance (FIG. 5) where a correct password is employed and, by way of comparison, in an instance (FIG. 6) where the access conditions are not fulfilled.

Turning first therefore to FIG. 5, the appropriate entity 26 provides an indication at 82 by way of provision of a read file 84 to the ME 28 that the entity wishes to read a file defined in the “restricted read” domain. The path name within the read file indication 84 comprises the particular path to the file to be read such as “/partition I/directory I/picture 1.jpg”.

A read_element_request 86 is subsequently sent from the ME 28 to UICC 30.

As illustrated within FIG. 5 a password verification sequence 88 is applied to the file itself and also to the preceding directories and which may be protected by passwords and, in this case, the password verification sequence comprising signaling and indications 90-98 such as illustrated in FIG. 5 is provided.

Initially, an access_condition_notification signal 90 is delivered from the UICC 30 to the ME 28 and in turn, a password required indication 92 is provided from the ME 28 to the entity 26 which, returns with a verified password attempt 94 which, in turn initiates a verify_password_request 96 from the ME 28 to the UICC 30.

The verify password_result 98 is then returned from the UICC 30 to the ME 28 so as to complete the password verification sequence 88.

With the password having been verified, a read element result 100 including the required data is delivered from the UICC 30 to the ME 28 so that the read file result including the required data can be delivered 102 in turn to the requesting entity 26.

Turning now to FIG. 6, a sequence is illustrated in relation to an attempt by one entity to read a file defined in the “private” domain by another different entity at 104 and a read file indication 106 is provided to the ME 28.

A read_element_request 108 is then delivered from the ME 28 to the UICC 30 in which it should be appreciated that the entity_id is different from the file-owner entity_id.

The UICC 30 realizes that the domain of the file comprises a “private” domain and therefore only the owner of the file can access it. Since the entity_id that it is received does not match the owner entity_id, the read request is rejected within the read_element_result 110 delivered from the UICC 30 to the ME 28.

A read file result indication 112 is then provided from the ME 28 to the requesting entity 26 and the result indicates a reading failure such that the data parameter therein is null.

It should of course be appreciated that the invention is not limited to the details of the foregoing embodiment.

Although an implementation (that would involve creating new APDU commands supporting the same features as describes in this document) for applications running over the USB Smart Card ICCD interface class is not explicitly described, the same principles as those outlined above could be applied to such an ICCD class.

Also, for a scenario involving of UICC supporting the USB mass storage interface class, if a data element saved by an entity (such as a ME) in such a UICC is accessible without password verification, i.e. no password required for the data element itself nor for its parent data elements, this data element should be also accessible when the UICC, configured and behaving like a USB mass storage device, is connected to a device such as for example a PC.

Data elements which are password-protected must remain inaccessible when the UICC is configured as a USB mass storage device and connected to a device which doesn't support the password verification process.

Thus, in further detail, with a UICC embodied to be configured as a USB mass storage device, and connected to a remote device such as a PC, the UICC can behave in the manner of a simple USB memory stick. Then data elements on the UICC which have been saved by a ME, or indeed any other device, without a password, i.e. in the “public” domain as outlined above, should remain accessible at the PC.

However, for data elements that are protected by a password, they remain inaccessible when the UICC, behaving in the manner of a memory stick, is connected to the PC.

For example, user takes a photo using the ME's camera and saves it in the UICC without password. When the user then plugs the UICC into a PC, byway of an electrical adapter, the UICC will behave like a USB memory stick, and the photo will be accessible on the PC. However, if the user had saved the photo with a password, this photo will not be visible when the UICC is plugged to the PC.

### <Incorporation by Reference>

This application is based upon and claims the benefit of priority from UK Patent Application No. 0900664.4, filed on Jan. 16, 2009, the disclosure of which is incorporated herein in its entirety by reference.

### REFERENCE SIGNS LIST

10 UICC
12 processing functionality
14 storage area
16 interface
20 processor
22 standard memory
24 transmit/receive functionality
26 user
28 ME
30 UICC
32 request
34 appropriate request operation
36 Create_Element_Request
38 password verification sequence8
40 access_condition_notification signal0
46 verify_password_request signal6
48 verify_password_result signal8
50 create_element result signal0
52 set_domain_request signal
54 set_domain_result signal
56 set_password_request signal
60 creative directory result signal
64 create file request
66 create_element_request
70 create_element_result
72 set_domain_request signal
74 set_domain_results signal
76 a set_password_request
78 set_password_result
80 file result indication
82 indication at2
84 read file indication
86 read_element_request
90 access_condition_notification signal
92 password required indication
94 verified password attempt
96 verify_password_request
98 verify password_result
100 read element result0
102 delivered
106 read file indication
108 read_element_request
110 read_element_result
112 read file result indication

1. A method of data protection in a circuit card arranged for storage of a plurality of data elements comprising:
providing protection on the basis of one of a domain protection-element serving to define operations that can be permitted on a data element and a password protection-element serving to control access to a data element,
wherein at least one of the said plurality of data elements is associated with both the domain protection-element and the password-protection element.

2. The method of data protection according to claim 1, wherein, for the said at least one data element, a password is required to initiate the operation permitted, and the operation is defined by the domain protection-element.

3. The method of data protection according to claim 1, further comprising using a PIN code access to one or more applications of the circuit card.

4. The method of data protection according to claim 1, wherein each of said plurality of data elements is associated with the domain protection-element.

5. The method of data protection according to claim 1, wherein permitted operations defined by the domain protection-element comprise one or more of read and/or write access operations.

6. The method of data protection according to claim 1, wherein an entity that is capable of accessing data in the circuit card is associated with a unique identifier.

7. The method of data protection according to claim 6, further comprising storing the identifier of the entity creating the data element.

8. The method of data protection according to claim 6, wherein the circuit card is arranged to store the identifier of the entity of the data element.

9. The method of data protection according to claim 6, within an ME, identifying an entity requiring access to the said data.

10. The method of data protection according to claim 1, wherein the data protection is applied over a USB interface class when the USB interface is activated between the ME and the circuit card.

11. The method of data protection according to claim 1, comprising storing the data element on the circuit card in accordance with a standard file format file system.

12. The method of data protection according to claim 1, wherein creation and management of the data elements within the circuit card is controlled by way of the ME.

13. The method of data protection according to claim 1, wherein ME circuit-card interface functions are defined as including one or more of a creation function, read function, update function, rename function, move function, delete function and cleaning function.

14. The method of data protection according to claim 1, wherein the circuit card comprises a UICC.

15. A circuit card arranged for storing a plurality of protectable data elements comprising:
at least one of the said plurality of protectable data elements that are arranged to be associated with both a domain protection-element serving to define operations that can be permitted on the data element and a password protection-element that serves to control access to the data element.

16. The circuit card according to claim 15, wherein a password is required to initiate the operation permitted by the domain protection-element.

17. The circuit card according to claim 15, wherein each of the plurality of data elements is associated with the domain protection-element.

18. The circuit card according to claim 15, wherein the circuit card is arranged to allow access to the said data elements by way of a USB interface class.

19. The circuit card according to claim 15 further comprising a UICC.

20. The circuit card according to claim 15, wherein, the circuit card is configured as a USB mass storage device and arranged for connection to a remote device, and wherein data elements not associated with the password protection-element are accessible at the remote device, and data elements associated with the password protection-element are inaccessible at the remote device if this device does not support a password verification mechanism.

21. A mobile radio communications device arranged for operating with a circuit card as defined in claim 15.

22. The mobile radio communications device according to claim 21, wherein the mobile radio communications device is arranged to communicate with the circuit card by way of a USB interface class.

23. The mobile radio communications device according to claim 21, wherein the mobile radio communications device is arranged to create and/or manage the said stored data elements.
